(19) United States
(12) Patent Application Publication
(10) Pub. No.: US 2026/0094976 A1
(43) Pub. Date: Apr. 2, 2026

(54) LOW CONDUCTIVITY FREQUENCY SELECTIVE SURFACES FOR A FABRY PEROT CAVITY ANTENNA CONFIGURATION

(71) Applicant: CORNING INCORPORATED, CORNING, NY (US)

(72) Inventors: Ryan Cadwell, Corning, NY (US); Prateek Juyal, Painted Post, NY (US); Cheolbok Kim, Painted Post, NY (US); Anthony Ng'oma, Horseheads, NY (US)

(21) Appl. No.: 19/339,703

(22) Filed: Sep. 25, 2025

Related U.S. Application Data
(60) Provisional application No. 63/702,010, filed on Oct. 1, 2024.

(51) Int. Cl. H01Q 21/06; H01Q 13/10; H01Q 21/00

(52) U.S. Cl. CPC H01Q 21/065; H01Q 13/106; H01Q 21/0043

(57) ABSTRACT

Embodiments of an antenna are provided. The antenna has a substrate with a first major surface and a second major surface. A ground plane is spatially disposed a first distance from the second major surface of the substrate, and a patch array is disposed on the second major surface between the substrate and the ground plane. Patches of the patch array are made of a material having a conductivity of 1×10⁶ S/m or more, and the patches of the patch array are printed onto the second major surface of the substrate.

### CROSS-REFERENCE TO RELATED APPLICATIONS

This application claims the benefit of priority under 35 U.S.C. § 119 of U.S. Provisional Application No. 63/702,010 filed Oct. 1, 2024, the content of which is incorporated herein by reference in its entirety.

### FIELD

The disclosure relates to planar antennas and, in particular, to planar antennas having a frequency selective surface in a Fabry-Perot cavity type configuration.

### BACKGROUND

Emerging wireless technologies, including 5G and 6G telecommunications and various sensing and imaging systems, tends to operate in the millimeter waveband and at sub-terahertz frequencies. This waveband offers greater bandwidth, thereby enabling enhanced functionality, for applications such as autonomous cars and augmented and virtual reality, amongst others. However, signal losses are also greater at these frequencies, and high gain antennas are required for communication. Conventionally, for planar antennas, gain can be enhanced using a dielectric superstrate or by designing antenna arrays. One of the effective methods recently developed is to use frequency selective surface (FSS) in a Fabry Perot cavity (FPC) type antenna configuration. FPC antenna configuration has an advantage over both arrays and dielectric superstrates as it uses simple feeding and can be designed on thin and lower dielectric constant substrates. Various configurations and topologies of FSS have been studied for gain enhancement in which FSS patterns are conventionally made of high conductive material such as copper.

### SUMMARY

According to a first aspect, embodiments of the disclosure relate to an antenna. The antenna comprises a substrate having a first major surface and a second major surface. A ground plane is spatially disposed a first distance from the second major surface of the substrate, and a patch array is disposed on the second major surface between the substrate and the ground plane. Patches of the patch array are comprised of a material having a conductivity of 1×10⁶ S/m or more, and the patches of the patch array are printed onto the second major surface of the substrate.

According to a second aspect, embodiments of the disclosure relate to a method of fabricating an antenna. In the method, patches of a material are deposited on a substrate to define a patch array. The substrate has a first major surface and a second major surface, and the material is deposited on the second major surface. A ground plane is arranged a first distance from the substrate such that the patch array is disposed between the substrate and the ground plane. The material of the patches comprises a conductivity in a range from 1×10⁶ S/m to 5×10⁷ S/m.

According to a third aspect, embodiments of the disclosure relate to a method of transmitting a signal having a frequency in a range from 10 GHz to 1 THz. In the method, the signal is received from a source antenna at the antenna according to the first aspect. The signal is reflected between the patch array and the ground plane, and the signal is transmitted through the first major surface of the substrate at a gain of at least 10 dBi.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a side view of a Fabry-Perot cavity type antenna, according to an exemplary embodiment of the present disclosure;

FIG. 2 is a view of the face of the frequency selective surface of the Fabry-Perot cavity type antenna shown in FIG. 1, according to an exemplary embodiment of the present disclosure;

FIG. 3 depicts top and side views of patches of a frequency selective surface patch array for a printed patch, according to an exemplary embodiment of the present disclosure, as compared to a conventional etched or electroplated patch;

FIG. 4 is a graph of realized gain as a function of frequency for materials of a patch array having different conductivity, according to exemplary embodiments of the present disclosure;

FIG. 5 is a graph of reflection coefficient as a function of frequency for materials of a patch array having different conductivity, according to exemplary embodiments of the present disclosure;

FIG. 6 is a graph of realized gain as a function of conductivity of patch material of a patch array, according to exemplary embodiments of the present disclosure;

FIG. 7 is a graph of radiation efficiency as a function of conductivity of patch material of a patch array, according to exemplary embodiments of the present disclosure; and

FIG. 8 is a graph of gain enhancement as compared to source reference for an antenna with a copper patch array and for an antenna with an indium tin oxide patch array, according to exemplary embodiments of the present disclosure.

### DETAILED DESCRIPTION

Reference will now be made in detail to various embodiments of a Fabry-Perot cavity (FPC) type antenna in which the frequency selective surface (FSS) is formed using materials with a conductivity as low as 1×10⁶ S/m, examples of which are illustrated in the accompanying drawings. As will be discussed more fully below, the broadening of the usable materials for such FPC-type antennas allows for fabrication of the antennas using new techniques not previously available for conventional high conductivity (e.g., >1×10⁷ S/m) materials. To the inventors' knowledge, the effect of FSS conductivity on the peak gain performance of FPC antenna configuration has not previously been investigated. The inventors surprisingly and unexpected discovered that the FPC antenna can also be designed using less conductive FSS materials with minimal loss in antenna peak gain. Such a finding is contrary to other conventional planar antenna designs, such as microstrip arrays, where significant loss in peak gain results from a decrease in conductivity. In this regard, the design space for high gain antennas is greatly increased, allowing the use of relatively low conductivity and transparent materials, such as transparent conductive oxides (e.g., indium tin oxide) and glass, or the use of relatively low conductive metallic ink in printing. These and other aspects and advantages of will be described in relation to the embodiments provided below and in the drawings. These embodiments are presented by way of example and not by way of limitation.

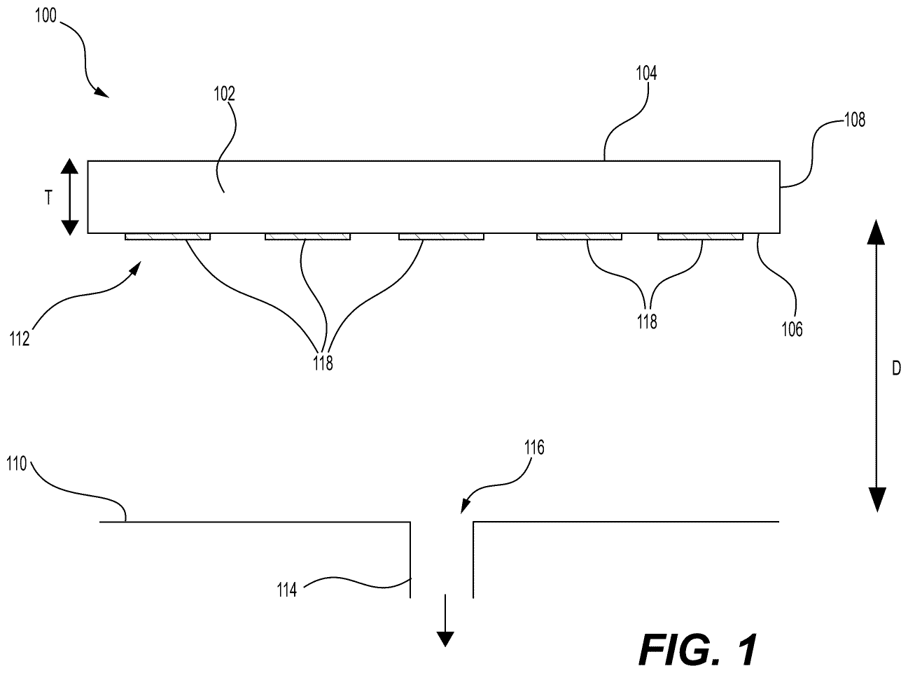

FIG. 1 depicts an exemplary embodiment of an antenna 100 according to the present disclosure. The antenna 100 includes a substrate 102 having a first major surface 104 and a second major surface 106. The second major surface 106 is opposite to the first major surface 104. A minor surface 108 connects the first major 104 surface to the second major surface 106 around a periphery of the substrate 102. A ground plane 110 is spatially disposed a first distance D from the substrate 102. In one or more embodiments, the first distance D is about 0.5λ, wherein λ is the antenna operating wavelength in free space. As used herein, the term “about” encompasses values within 20%, such as within 15%, 10%, 5%, or 2.5%, of the stated value (i.e., +/−20%, such as +/−15%, +/−10%, +/−5%, or +/−2.5%).

A patch array 112 is disposed on the second major surface 106 between the substrate 102 and the ground plane 110. The patch array 112 defines the FSS for the operation band of the antenna 100. In one or more embodiments, the ground plane 110 further comprises a receiver or transmitter, such as a waveguide probe antenna 114, a waveguide slot antenna, or a microstrip or patch antenna. In the embodiment shown in FIG. 1, the receiver or transmitter is depicted as a waveguide probe antenna 114 having an opening 116 extending through the ground plane 110. As would be understood by one of ordinary skill in the art, the antenna 100 defined by the structure depicted in FIG. 1 is of the FPC-type, which are highly directive planar antennas also providing high gain.

In one or more embodiments, the substrate 102 is selected from a group consisting of fused silica, quartz, alumina, and FR-4, amongst other possibilities. In embodiments, the fused silica can be high-purity fused silica (HPFS). As used herein, “HPFS” is silica that contains less than 1 ppb of water (OH) measured using Fourier-transform infrared spectroscopy (FTIR) and less than 1 ppb of alkali and metal impurities measured using inductively coupled plasma mass spectrometry (ICP-MS). In one or more embodiments, the substrate 102 is transparent such that the substrate transmits at least 70%, at least 80%, or at least 90% of light having a wavelength in a range of 380 nm to 750 nm incident on the first major surface through the second major surface. Advantageously, such transparent substrates 102 can be used for window applications (e.g., architectural or vehicle glazing). In one or more embodiments, the substrate 102 comprises a thickness T between the first major surface 104 and the second major surface 106, and the thickness T is in a range of from 0.1λ to 0.6λ, such as from 0.1λ to 0.5λ, from 0.1λ to 0.4λ, from 0.2λ to 0.5λ, or from 0.2λ to 0.4λ, where λ is the antenna operating wavelength in the substrate 102 (i.e., taking into account the dielectric properties of the substrate 102).

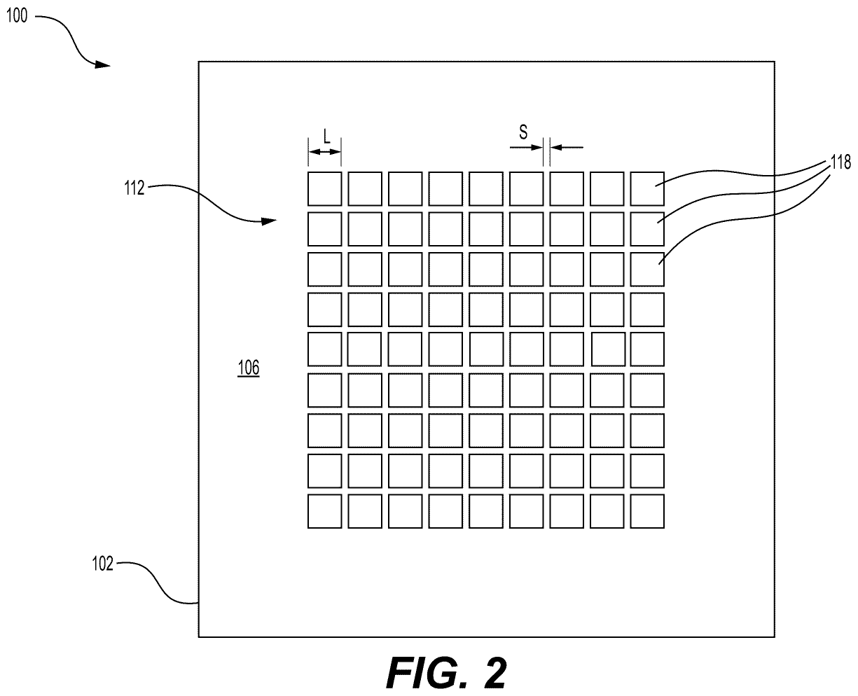

FIG. 2 depicts an example embodiment of a patch array 112 according to the present disclosure. In one or more embodiments, the patch array 112 comprises an array of patches 118 having an array size in a range from 5×5 to 1000×1000. In one or more embodiments, the patch array 112 comprises patches 118 having any of a variety of shapes, such as squares, rectangles, circles, dipoles, ellipses, triangles, disc sectors, circular rings, or ring sectors, amongst other possibilities. In the embodiment shown in FIG. 2, the patch array 112 comprises patches 118 having a square shape. In one or more embodiments, a spacing S between adjacent patches 118 is about 0.1λ, where λ is the antenna operating wavelength in the substrate 102. In one or more embodiments, the antenna 100 is configured for use at a frequency in a range from 10 GHz to 1 THz, corresponding to operational wavelengths (λ) in free space in a range of 0.3 mm to 3 cm. In one or more embodiments, each patch 118 comprises a patch dimension L in a range of from 0.1λ to 0.6λ, such as from 0.1λ to 0.5λ, from 0.2λ to 0.6λ, or from 0.2λ to 0.5λ, where λ is the antenna operating wavelength in the substrate 102. Depending on the shape of the patch 118, the patch dimension L could be a side length (e.g., of a square), a radius (e.g., of a circle or disc sector), or a height (e.g., of a triangle).

Patches 118 of the patch array 112 are comprised of a material having a conductivity as low as 1×10⁶ S/m, in particular in a range of 1×10⁶ S/m to 1×10⁸ S/m, and most particularly in a range of 1×10⁶ S/m to 1×10⁷ S/m. In one or more embodiments, the material for the patches 118 is selected to have a conductivity less than that of copper, in particular a conductivity of 5×10⁷ S/m or less. In one or more embodiments, the material is selected from a group consisting of a conductive metal oxide (e.g., indium tin oxide), a metallic ink, bronze, brass, aluminum, stainless steel, tin, or combinations thereof. Advantageously, expanding the range of conductivity for the patches allows for the use of materials that can be processed differently, such as using various printing techniques. For example, in one or more embodiments, the patches 118 are printed on the substrate using inkjet printing, aerosol jet printing, or screen printing, amongst others. In another example according to one or more embodiments, the patches 118 are deposited on the substrate using physical vapor deposition, sputtering, chemical vapor deposition, or electroplating, amongst other possibilities. Such deposition processes use less materials and may allow for faster processing of the patches 118. In contrast, conventional etching techniques require deposition of a film, application of accurate masks, and removal of the film in negative areas, potentially leading to waste. Further, conventional electroplating techniques require exact application of masks to define the desired deposition locations, and electroplating takes time to build up the desired layer thickness.

After the deposition of the patch array 112, the substrate 102 is arranged at the first distance D from the ground plane 110 with the patch array 112 facing the ground plane 110. As mentioned above, the ground plane 110 may include an emitter or receiver to transmit outgoing signals or receive incoming signals.

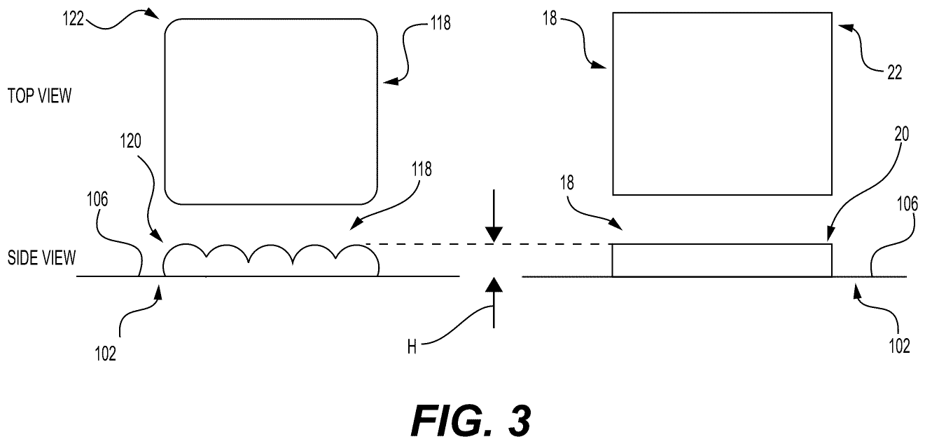

FIG. 3 depicts a comparison of a patch 118 deposited via a printing process according to embodiments of the present disclosure as compared to a patch 18 formed via conventional etching or electroplating processes. As can be seen from the side view, each patch 118, 18 has a maximum height H above the second major surface 106 of the substrate 102. The printed patch 118 has as variable height H across the top surface as well as rounded vertices 120 along the edges. In one or more embodiments, the height H of the printed patch 118 may vary by as much as 20% (100×(maximum height−minimum height)/maximum height), in particular in a range from 5% to 20%, and most particularly in a rage from 10% to 20%, across the top surface of the printed patch 118. For printed patches 118, this results from the formation of the patch 118 from droplets of the patch material that are deposited and merge on the second major surface 106 of the substrate 102 as well as the effect of solvent evaporation after deposition. By comparison, the conventional patch 18 has substantially sharp, angular vertices 20 and consistent height H across the top surface. This results from the process of removing a portion of a film around a mask or depositing a film within a cavity defined by a mask. Further, as shown in the top view of the patches 118, 18, the patch 118 deposited by a printing process has rounded corners 122 where two linear sides meet, whereas the patch 18 deposited by a conventional etching or electroplating process has substantially angular corners 22 where two linear sides meet. The embodiment of the printed patch 118 shown in FIG. 3 is square in shape, but the rounded corners 122 would be present for any polygonal shape. Further, the rounded vertices 120 along the vertical edge and variable height H would generally be present for any curved or linear edges defining the shape of the patch 118.

### Experimental Examples

Having described the general structure of the antenna 100, an antenna according to the present disclosure was constructed. The source antenna was a waveguide probe antenna (Product No. PEWAN1124, Pasternack Enterprises, Irvine, CA, USA), such as schematically depicted in FIG. 1. The patch array 112 was printed on a high purity fused silica (HPFS) substrate 102. The thickness T of the HPFS substrate 102 was 0.5 mm, and the HPFS substrate 102 was square with a side length of 10 mm. The patch array 112 was spaced a first distance D of 1 mm from the ground plane 110.

To test the effect of the material conductivity on the performance of the antenna 100, square patches 118 of different materials were deposited on the HPFS substrate 102 in 9×9 patch arrays 112. Specifically, the material of the patches 118 were selected to be copper, aluminum, bronze, and indium tin oxide (ITO). The dimensions of the patches 118 and patch array 112 were optimized for maximum antenna gain in the band of 150 GHz to 170 GHz. In this regard and with reference to FIG. 2, the patch dimension L was 0.55 mm, and the spacing S between adjacent patches was 0.15 mm. The 9×9 patch array 112 was selected to maximum aperture efficiency; although, high gain enhancement could have been achieved using an 11×11 or 13×13 path array 112. The 9×9 patch array 112 defined an area with a side length of 6.15 mm.

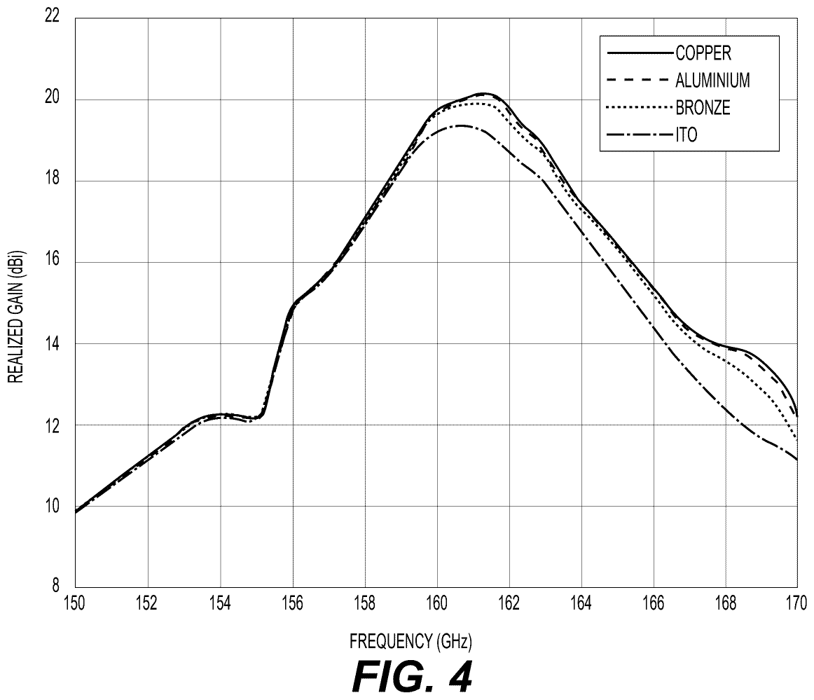

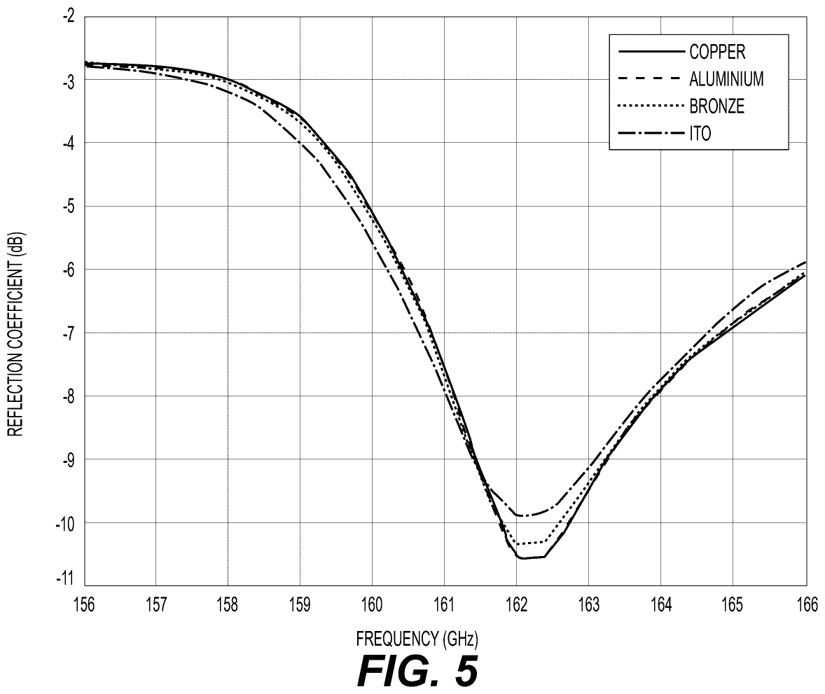

As shown in the graph of FIG. 4, the antenna 100 enhanced the gain of the waveguide probe antenna from a baseline of 6.5 dBi for the reference antenna to 20.1 dBi. It should be noted that, while the antenna was configured to enhance gain in the frequency range of 150 GHz to 170 GHz, the same enhanced gain (as well as other properties measured herein) can be achieved at any frequency by adjusting the dimensions of the patches 118 and patch array 112 for the desired frequency range. That is, the properties of the disclosed antenna 100 are scalable. FIG. 5 provides a graph of the reflection coefficient as a function of frequency for the designed antenna 100 with patches 118 of materials with different conductivity. From these graphs, it can be seen that the material with the highest conductivity (copper) performed the best in terms of maximum realized gain (FIG. 4) and minimum reflection coefficient (FIG. 5). However, surprisingly and unexpectedly, the decrease in such properties for the lowest conductivity material (ITO) was relatively minor despite the ˜60× lower conductivity. In particular, the difference in maximum realized gain was 0.78 dBi, and the difference in minimum reflection coefficient was at most 0.5 dB across the frequency spectrum.

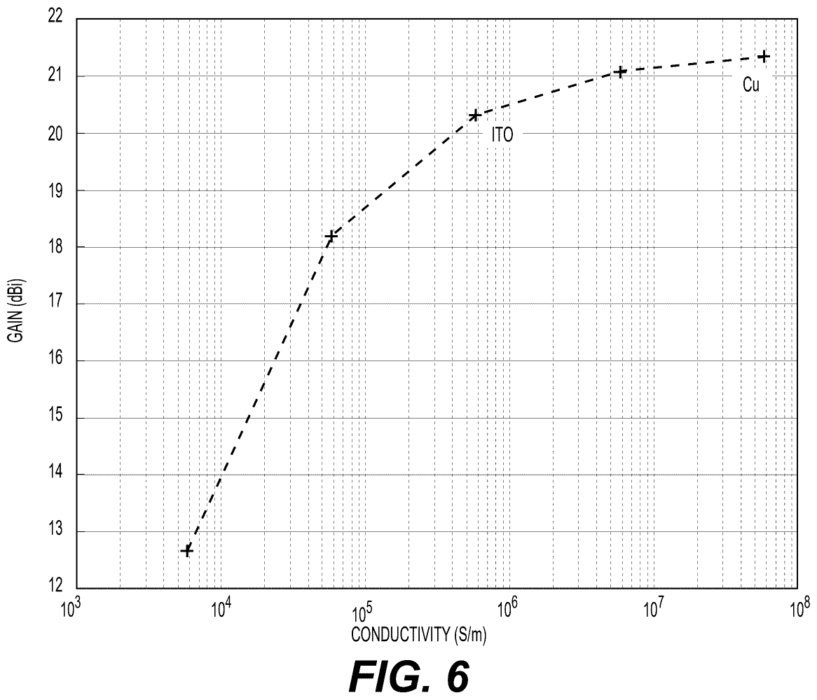

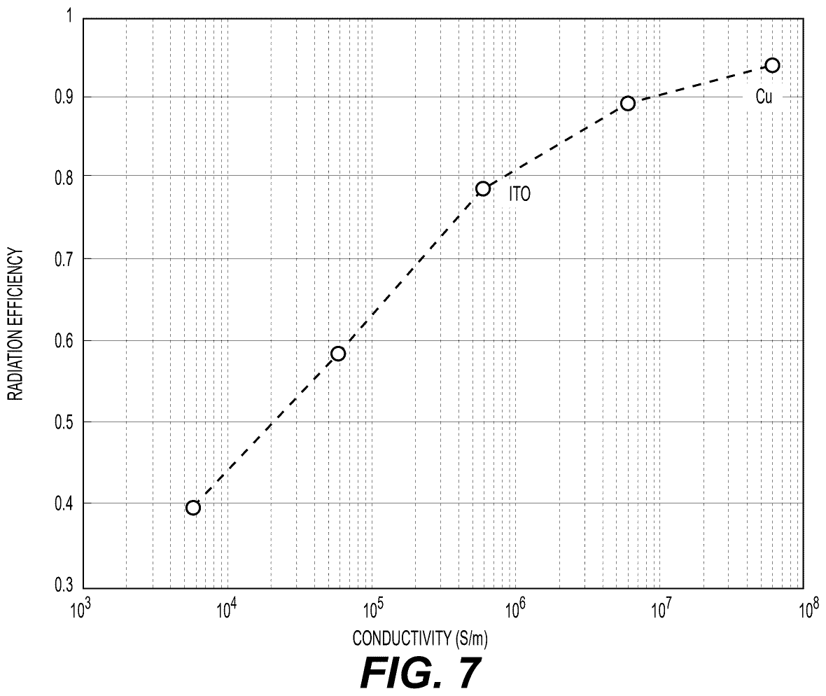

Further, to quantify the effect of conductivity on the antenna gain and efficiency performance, the conductivity of the material of the patches of the patch array with respect to copper was varied, ranging from bulk copper conductivity to 0.01% of copper conductivity. FIGS. 6 and 7 graphically depict the effect of material conductivity on the peak gain and radiation efficiency. For ITO, the peak gain and radiation efficiency drop is limited to 0.8 dBi and 11%, respectively, as compared to copper.

Table 1 provides a summary of the gain enhancement and radiation efficiency of the antennas having the patches of different materials and associated conductivities.

TABLE 1
Summary of Antenna Properties for Various Materials

| | Copper | Aluminum | Bronze | ITO |
|---|---|---|---|---|
| Conductivity (S/m) | 5.8 × 10⁷ | 3.8 × 10⁷ | 1 × 10⁷ | 1 × 10⁶ |
| Peak Realized Gain (dBi) | 20.14 | 20.10 | 19.92 | 19.38 |
| Radiation Efficiency (%) | 94 | 94 | 91 | 83 |

The analysis, as summarized in Table 1, demonstrates that a relatively low conductivity ITO can be used to provide a transparent patch array 112 in a Fabry-Perot cavity type antenna 100 with minimal loss in the antenna performance. As mentioned above, the ability to use lower conductivity materials broadens not only the scope of materials that can be used but also the deposition techniques available for the fabrication of such antennas. It should be appreciated that Table 1 is intended to be more specific, indicating properties at specific conductivities, whereas FIGS. 6 and 7 are intended to be more general, illustrating general trends in peak gain and radiation efficiency for a range of conductivities.

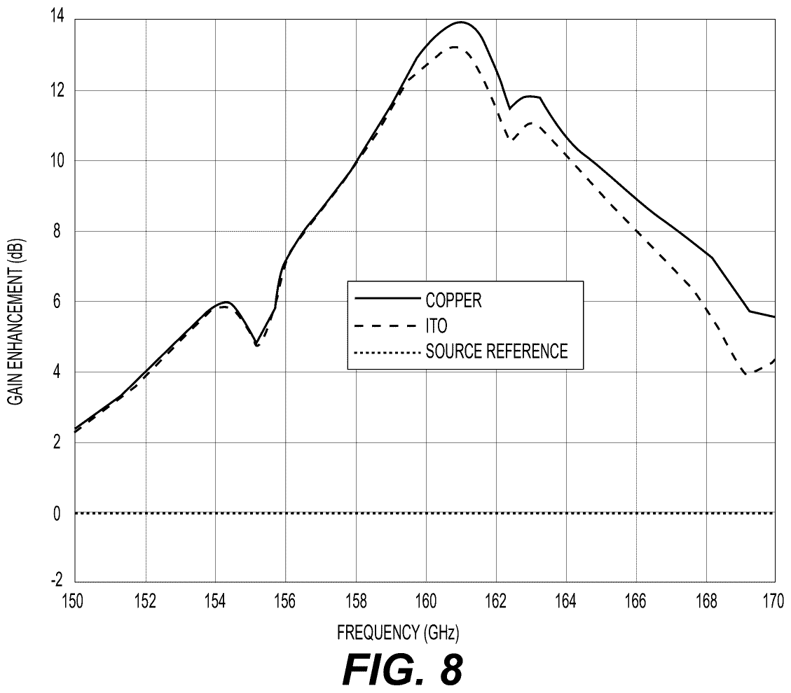

FIG. 8 shows the gain enhancement comparison using copper and ITO as the material of the patch array 112 with the source antenna as reference. Gain enhancement in ITO was about 13 dB as compared to about 13.8 dB in copper. Again, this result demonstrates that there is minimal diminishment in terms of antenna performance when using the low conductivity ITO material in place of the copper.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. An antenna, comprising:
a substrate having a first major surface and a second major surface;
a ground plane spatially disposed a first distance from the second major surface of the substrate; and
a patch array disposed on the second major surface between the substrate and the ground plane;
wherein patches of the patch array are comprised of a material having a conductivity of 1×10⁶ S/m or more; and
wherein the patches of the patch array are printed onto the second major surface of the substrate.

2. The antenna of claim 1, wherein the patch array comprises an array size in a range from 5×5 to 1000×1000.

3. The antenna of claim 1, wherein the patches of the patch array have a spacing of about 0.1λ and wherein λ is an operating wavelength of the antenna in the substrate.

4. The antenna of claim 1, wherein the patches of the patch array have a patch dimension in a range of 0.2λ to 0.5λ and wherein λ is an operating wavelength of the antenna in the substrate.

5. The antenna of claim 1, wherein the patches of the patch array have a shape of square, rectangle, circle, dipole, ellipse, triangle, disc sector, circular ring, or ring sector.

6. The antenna of claim 1, wherein the first distance is about 0.5λ and wherein λ is an operating wavelength of the antenna in free space.

7. The antenna of claim 1, wherein the material is selected from a group consisting of a conductive metal oxide, a metallic ink, bronze, brass, aluminum, stainless steel, tin, copper, and combinations thereof.

8. The antenna of claim 1, wherein the substrate is selected from a group consisting of fused silica, quartz, alumina, and FR-4.

9. The antenna of claim 1, wherein the substrate comprises a thickness between the first major surface and the second major surface, the thickness being in a range of 0.1λ to 0.5λ and wherein λ is an operating wavelength of the antenna in the substrate.

10. The antenna of claim 1, configured for use at a frequency in a range from 10 GHz to 1 THz.

11. The antenna of claim 1, further comprising a source antenna disposed on the ground plane, the source antenna being a waveguide probe antenna, waveguide slot antenna, or a microstrip antenna.

12. The antenna of claim 1, wherein a peak realized gain of the antenna is at least 18 dBi.

13. The antenna of claim 1, wherein a gain enhancement of the antenna relative to a source antenna is at least 10 dB.

14. The antenna of claim 1, wherein a minimum reflection coefficient of the antenna is at least |9.5| dB.

15. The antenna of claim 1, comprising a radiation efficiency of at least 80%.

16. The antenna of claim 1, wherein the substrate is transparent such that the substrate transmits at least 70% of light having a wavelength in a range of 380 nm to 750 nm incident on the first major surface through the second major surface.

17. The antenna of claim 1, wherein each patch of the patch array comprises a deposition surface that extends from the second major surface at a variable height.

18. The antenna of claim 1, wherein each patch of the patch array comprises rounded corners, rounded vertices along vertical edges, or both rounded corners and rounded vertices along vertical edges.

19. A method of fabricating an antenna, comprising:
depositing patches of a material on a substrate to define a patch array, the substrate having a first major surface and a second major surface and the material being deposited on the second major surface;
arranging a ground plane a first distance from the substrate such that the patch array is disposed between the substrate and the ground plane; and
wherein the material of the patches comprises a conductivity in a range from 1×10⁶ S/m to 5×10⁷ S/m.

20. The method of claim 19, wherein depositing the patches comprises inkjet printing, aerosol jet printing, or screen printing the patches on the second major surface of the substrate.

21. The method of claim 19, wherein depositing the patches comprises depositing the patches on the second major surface of the substrate via chemical vapor deposition, physical vapor deposition, sputtering, or electroplating.

22. The method of claim 19, wherein the material is selected from a group consisting of a conductive metal oxide, a metallic ink, bronze, brass, aluminum, stainless steel, tin, and combinations thereof.

23. The method of claim 19, wherein the substrate is selected from a group consisting of fused silica, quartz, alumina, and FR-4.

24. The method of claim 19, wherein the patches of the patch array have a patch dimension in a range of 0.2λ to 0.5λ and λ is an operating wavelength of the antenna in the substrate.

25. The method of claim 19, wherein the patches of the patch array have a spacing of about 0.1λ and λ is an operating wavelength of the antenna in the substrate.

26. The method of claim 19, wherein the first distance is about 0.5λ and λ is an operating wavelength of the antenna in free space.

27. The method of claim 19, wherein depositing the patches further comprises depositing the patches in a patch array having an array size in a range from 5×5 to 1000×1000.

28. The method of claim 19, wherein the substrate comprises a thickness between the first major surface and the second major surface, the thickness being in a range of 0.1λ to 0.5λ and λ is an operating wavelength of the antenna in the substrate.

29. A method of transmitting a signal having a frequency in a range from 10 GHz to 1 THz, the method comprising:
receiving the signal from a source antenna at the antenna according to claim 1;
reflecting the signal between the patch array and the ground plane; and
transmitting the signal through the first major surface of the substrate at a gain of at least 10 dBi.

30. The method of claim 29, wherein a peak realized gain of the antenna is at least 18 dBi.

31. The method of claim 29, wherein a gain enhancement of the antenna relative to the source antenna is at least 10 dB.

32. The method of claim 29, wherein a minimum reflection coefficient of the antenna is at least 9.5 dB.

33. The method of claim 29, wherein the source antenna is a waveguide probe antenna, waveguide slot antenna, or a microstrip antenna.
